(19) United States
(12) Patent Application Publication
(10) Pub. No.: US 2008/0317304 A1
(43) Pub. Date: Dec. 25, 2008

(54) Electronic apparatus

(75) Inventor: Takashi Iijima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,872

(22) Filed: Jun. 25, 2008

(30) Foreign Application Priority Data
Jun. 25, 2007 (JP) 2007-165817
Jul. 23, 2007 (JP) 2007-191288

(51) Int. Cl. G06K 9/00

(52) U.S. Cl. 382/124

(57) ABSTRACT

An electoronic apparatus includes a first housing; a second housing that has a periphery having a first edge, and a second edge intersecting the first edge; and a coupling unit that has a first rotation axis in a direction intersecting with the surface of the first housing, and couples the first housing and the first edge of the second housing so that the second housing is rotatable about the first rotation axis with respect to the first housing. The electoronic apparatus further incldues; a fingerprint reading sensor provided on the first edge of the second housing; and an antenna that is incorporated into the second edge of the second housing.

### BACKGROUND OF THE INVENTION

1. Field of the Invention

The present invention relates to an electronic apparatus that includes a first housing and a second housing, which is coupled to the first housing so as to be relatively rotatable about a rotation axis that is intersects with the front face of the first housing.

2. Description of the Related Art

Notebook-size personal computers (hereinafter referred to as “notebook computer”) includes a main body housing, which has a keyboard on the front face thereof, and a display housing, which has a screen (for example, a liquid crystal display (LCD) panel) on the front face thereof. The display housing is coupled to the main body housing so as to be relatively rotatable about a horizontal axis parallel to the front face of the main body housing. Based on the rotation about the horizontal axis, the front face of the display housing is received by the front face of the main body housing.

Further, for example, a notebook computer called a compatible tablet PC can rotate about a vertical axis orthogonal to a horizontal surface, which includes the horizontal axis. Thus, the display housing rotates about the vertical axis. As a result, when the display housing is folded, the display housing can be received with the front face against the front face of the main body housing, and also with the back face against the front face of the main body housing.

Notebook computers provided with a sweep-type fingerprint reading sensor on the lateral portion of the display housing have been known (see, e.g., Japanese Patent Application Publication No. 2006-277073)).

In recent years, due to the usage of the screen by new operation systems and the display of HDTV broadcast images, adoption of screens with a 9:16 aspect ratio, so-called wide screens, instead of a conventional 3:4 aspect ratio, is becoming the mainstream in notebook computers. For notebook computers, on one hand, larger size screens are in demand as described above, while on the other, a smaller size contour is still in demand.

Accordingly, it is very difficult to mount a fingerprint reading sensor on the lateral portion of the display housing when an attempt to keep the conventional contour size is made while adopting such a wide screen. Particularly, when the fingerprint reading sensor is a sweep-type fingerprint reading sensor, a space is needed in which an operation by a finger is started from a position away from the fingerprint reading sensor for successful fingerprint reading.

Further, if the fingerprint reading sensor is mounted at a position disclosed in Japanese Patent Application Publication No. 2006-277073 on the display housing that has adopted such a wide screen, the distance from the vertical axis and the weight of the LCD panel due to the wide screen cause a problem that is the unintentional rotation of the display housing about the vertical axis during the operation by the finger for fingerprint reading by the fingerprint reading sensor, resulting in poor operability.

### SUMMARY OF THE INVENTION

The present invention has been made in view of the above circumstances and provides an electronic apparatus that includes an easy-to-use fingerprint reading sensor even in a display housing adopting a wide screen.

An electronic apparatus of the present invention includes a first housing; a second housing that has a periphery having a first edge, and a second edge intersecting the first edge; a coupling unit that has a first rotation axis in a direction intersecting with the surface of the first housing, and couples the first housing and the first edge of the second housing so that the second housing is rotatable about the first rotation axis with respect to the first housing; and a fingerprint reading sensor provided on the first edge of the second housing. In this manner, according to the present invention, since the fingerprint reading sensor is provided on the first edge of the second housing, the rotation of the second housing about the first rotation axis during the operation of the fingerprint reading sensor can be prohibited.

Further, the fingerprint reading sensor may read the fingerprint of the finger of the operation along the first edge. According to such a configuration, the operability of the electronic apparatus on which the fingerprint reading sensor involving such an operation by a finger is mounted is significantly increased.

Furthermore, the fingerprint reading sensor may be provided at a position on the first edge of the second housing where the first edge and the second edge intersect with each other. According to such a configuration, a user can easily operate his/her finger at the time of fingerprint reading, allowing for successful fingerprint reading.

Moreover, the second housing may have a slant face section oriented from a portion adjacent to an end of the fingerprint reading sensor, which is provided on a deeper location of the second housing than the front face of the second housing, to the front face of the second housing. According to such a configuration, the slant face section allows successful fingerprint reading operation by the finger.

Furthermore, the second housing may have an electronic component in the second housing on the second edge. The electronic component is preferably an antenna. Such a configuration allows an excellent receiving condition.

Further, the second housing may have a frame body that constitutes the periphery and houses the electronic component in the second housing on the second edge. According to such a configuration, the electronic component on the second edge is hidden and held by the second housing.

Further, the second housing may have an electronic component on the first edge. The electronic component may be an operating switch, or may be an indicator that indicates a predetermined operating state of the electronic apparatus. According to such a configuration, the operating switch and the indicator can be incorporated into the space on the first edge of the second housing reserved by the fingerprint reading sensor mounted on the first edge of the second housing; conversely, a fingerprint reading sensor can be incorporated into the space on the first edge of the second housing reserved by the operating switch and the indicator mounted on the first edge of the second housing.

Further, the second housing may have a frame body that constitutes the periphery and has the electronic component on the position of the first edge. According to such a configuration, the operating switch, indicator, or fingerprint reading sensor is held by the second housing with a substrate where each of them is installed hidden in the second housing.

Moreover, the coupling unit may have a second rotation axis that allows the second housing to be opened/closed with respect to the first housing, and is positioned on the side of the second housing, and parallel to the surface of the first housing. According to such a configuration, the fingerprint reading sensor can be used in various attitudes of the second housing, which may be caused by the first rotation axis and the second rotation axis.

Furthermore, the first housing may be an apparatus main section, and the second housing may be a display section having a screen. The display section, which is the second housing, may have an input device that allows a coordinate specification to be entered at a position of the screen.

The first housing may also have a keyboard on the surface.

Furthermore, an electronic apparatus of the present invention includes a first housing; a second housing that has a periphery having a first edge, and a second edge intersecting the first edge; a coupling unit that has a first rotation axis in a direction intersecting with the surface of the first housing, and couples the first housing and the first edge of the second housing so that the second housing is rotatable about the first rotation axis with respect to the first housing; a fingerprint reading sensor provided on the first edge of the second housing; and an antenna that is incorporated into the second edge of the second housing.

In this manner, according to this aspect of the present invention, since the fingerprint reading sensor is provided on the first edge of the second housing, the rotation of the second housing about the first rotation axis during the operation of the fingerprint reading sensor can be prohibited. Further, in this aspect of the present invention, the antenna is provided in the second housing on the second edge of the second housing, allowing for an excellent transmitting/receiving condition.

In this aspect of the present invention, the second housing may have a frame body that constitutes the periphery and houses the antenna in the second housing on the second edge. According to such a configuration, the electronic component on the second edge is hidden and held by the second housing.

Further, in this aspect of the present invention, the frame body may hold the display unit, which has a display screen where information is displayed, at a position inside from the periphery with the display screen exposed, and the antenna may be positioned at a more peripheral position than the display unit, along the second edge.

In the present invention, the antenna, which is a small-size component, is positioned on the second edge even in a display housing adopting a wide screen, allowing for an excellent transmitting/receiving condition.

Further, in this aspect of the present invention, another antenna may be incorporated at a position between the periphery of the frame body and the display unit.

According to the present invention, an electronic apparatus can be provided, which includes an easy-to-use fingerprint reading sensor even in a display housing adopting a wide screen.

### BRIEF DESCRIPTION OF THE DRAWINGS

FIG. 1 is an exterior view of an electronic device, that is, a notebook computer, according to an embodiment of the present invention in a state in which a display housing is closed over a main body housing;

FIG. 2 is an exterior view of the notebook computer of the present invention in a state in which the display housing is opened with respect to the main body housing;

FIG. 3 is an exterior view of the notebook computer of the present invention in a state in which the display housing is rotated from the state shown in FIG. 2, clockwise about a first rotation axis;

FIG. 4 is an exterior view of the notebook computer of the present invention in a state in which the display housing is further rotated from the state shown in FIG. 3, clockwise about the first rotation axis, as well as being rotated about a horizontal axis, and the display housing is closed over the main body housing;

FIG. 5 is a magnified view around a fingerprint reading sensor of the notebook computer in the state shown in FIG. 2;

FIG. 6 is an exterior view of the notebook computer in the state shown in FIG. 4 viewed from a Z1 direction to a Z2 direction;

FIG. 7 is a magnified view around the fingerprint reading sensor of the notebook computer in the state shown in FIG. 6;

FIG. 8 is a front view that shows only the display housing of the notebook computer of the present embodiment;

FIG. 9 is a front view of the display housing shown in FIG. 8 with the frame body around a LCD panel removed;

FIG. 10 is a perspective view of an antenna for wireless LAN (IEEE 802.11n);

FIG. 11 is a perspective view of an antenna for wireless LAN (IEEE 802.11b/g);

FIG. 12 is a perspective view of an antenna for UMTS, which is made of a metal sheet; and

FIG. 13 is a perspective view of the antenna for UMTS mounted on a substrate.

### DETAILED DESCRIPTION OF THE INVENTION

An embodiment of the present invention will now be described with reference to the drawings.

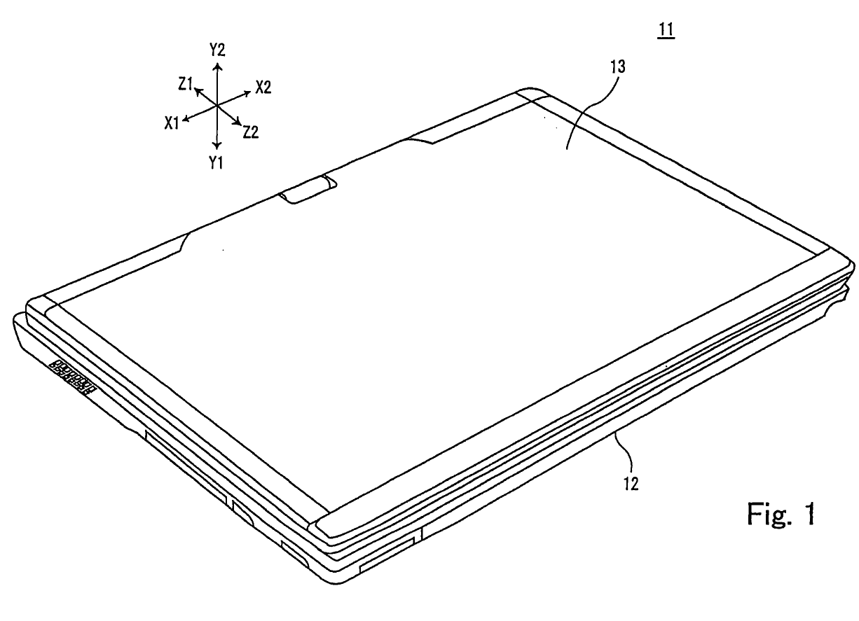

FIG. 1 shows the exterior appearance of an electronic apparatus, that is, a notebook-size personal computer 11 (hereinafter referred to as “notebook computer”) according to an embodiment of the present invention. The notebook computer 11 has a first housing, that is, a main body housing 12, and a second housing coupled to the main body housing 12, that is a display housing 13. The main body housing 12 and the display housing 13 are made of a reinforced resin material such as polycarbonate. Note that the display housing 13 may be made of a magnesium alloy (for example, Mg—Al—Zn) in order to increase the strength concomitantly to thinning. FIG. 1 shows a state in which the display housing 13 is closed over the main body housing 12.

The main body housing 12 incorporates a motherboard, for example. Electronic circuit components such as a central processing unit (CPU) and a memory are mounted on the motherboard. The CPU executes various computations, based on a software program (such as an operating system and an application program) and data temporarily stored in the memory, for example. Such a software program and data may be stored in a mass storage device such as a hard disk drive (HDD), which is also housed in the main body housing 12.

On the front face of the main body housing 12, input devices such as a keyboard 14 and a pointing device 15 are positioned. The keyboard 14 has a number of keys arranged within an arbitrary virtual plane. A user of the notebook computer 11 uses such input devices 14 and 15 to enter various instructions and data into the CPU.

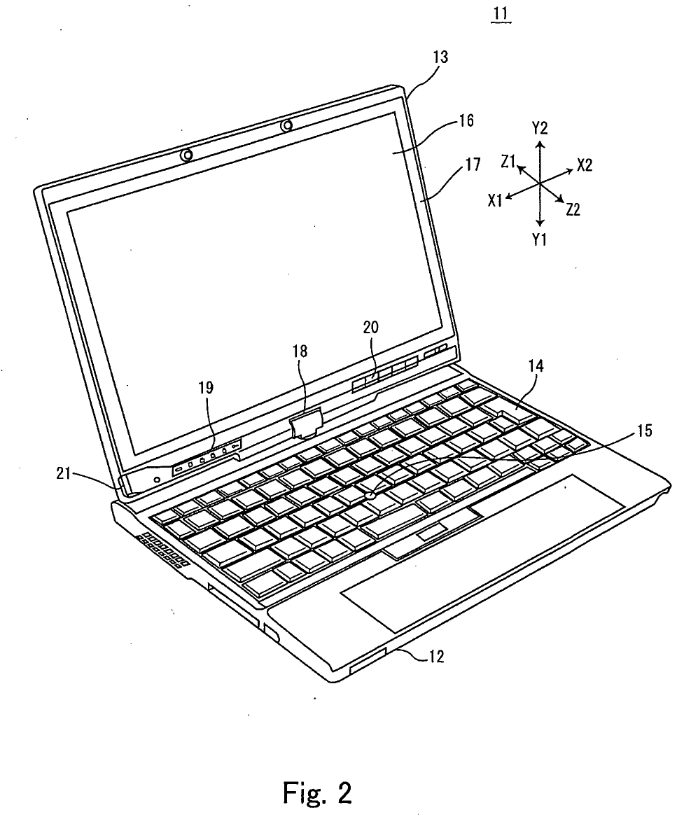

FIG. 2 shows the exterior appearance of the notebook computer 11 of the present invention in a state in which the display housing 13 is opened with respect to the main body housing 12.

The display housing 13 incorporates a flat display panel such as a wide liquid crystal display (LCD) panel 16 with a 9:16 screen aspect ratio, for example. The display housing 13 is provided with a frame body 17 forming the outline thereof with an opening defined on the inside. The LCD panel 16 is housed in the display housing 13 by the frame body 17 and a rear cover. The display screen of the LCD panel 16 is exposed on the front face of the display housing 13 through the opening in the frame body 17. Various texts and graphics are displayed on the display screen, based on the computations in the CPU. Further, the display housing 13 is provided with an electromagnetic induction-type digitizer on the back side of the LCD panel 16. The user can specify a coordinate by performing operations on the display screen with a stylus pen, and various commands and data can be entered into the CPU by specifying a display object on the display screen with a coordinate. Note that a touch panel may be disposed on the front face of the LCD panel 16 instead of the digitizer. Various types of touch panels may be used including an optical touch panel, a capacitance touch panel, an ultrasonic touch panel and a resistance film type touch panel. For example, if the touch panel is a resistance film type touch panel, the user can touch the touch panel with his/her finger to enter various commands and data into the CPU, based on the position the user touched.

The display housing 13 is coupled to the main body housing 12 by a biaxial rotation mechanism 18 (hereinafter referred to as “rotation mechanism”), which is a coupling unit. A rotation about a first rotation axis, that is to say, an axis (for example, an axis in the Y1-Y2 direction) intersecting the surface of the main body housing 12 on which the keyboard 14 is provided, and a rotation about a second axis, that is to say, a horizontal axis (an axis in the X1-X2 direction) parallel to the surface of the main body housing 12 on which the keyboard 14 is provided, are achieved by the rotation mechanism 18, between the main body housing 12 and the display housing 13. Here, the horizontal axis of the rotation mechanism 18 is coupled to the first edge of the display housing 13.

The frame body 17 exposes on the front face thereof and along the first edge of the display housing 13, an LED group 19 indicating predetermined operating states of the electronic apparatus, and an operating switch group 20. The LED group 19 includes multiple LEDs for a battery charge indication, a hard disk access indication, a Num Lock indication, a Caps Lock indication, a Scroll Lock indication, and a security indication, for example. Note that various operating states may be indicated by the LCD instead of the multiple LEDs. Further, the operating switch group 20 includes a Page Down button, a Page Up button, a screen rotation button, an Fn button, a Ctrl+Alt+Delete button, and a power button. A power on/off state indicator lamp is also provided next to the power button. Each of the LED group 19 and operating switch group 20 is implemented on a substrate, which is hidden by the frame body 17 and housed in the display housing 13.

Further, the display housing 13 is provided with a fingerprint reading sensor 21 on the first edge at a position where the second edge intersects with the first edge. The fingerprint reading sensor 21 is implemented on a substrate, the sensor section is operably exposed through the frame body 17, and the substrate is hidden by the frame body 17, and housed in the display housing 13.

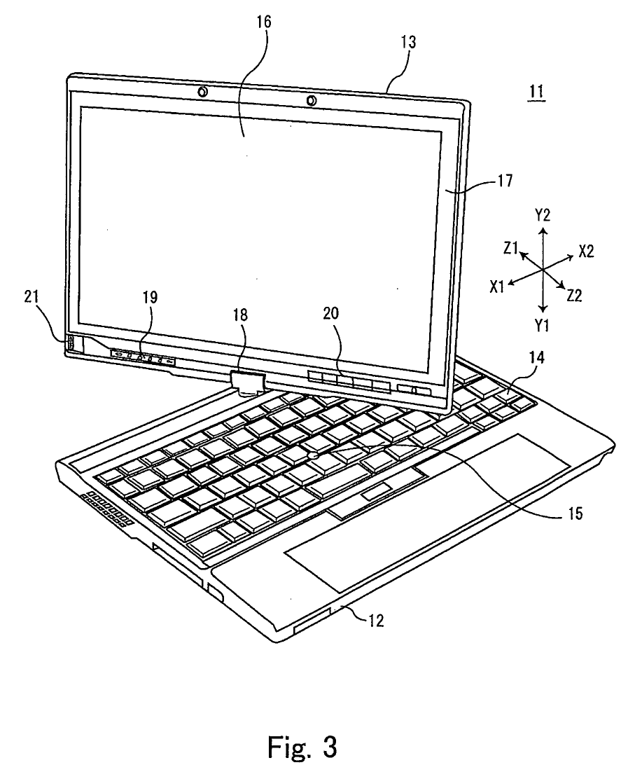

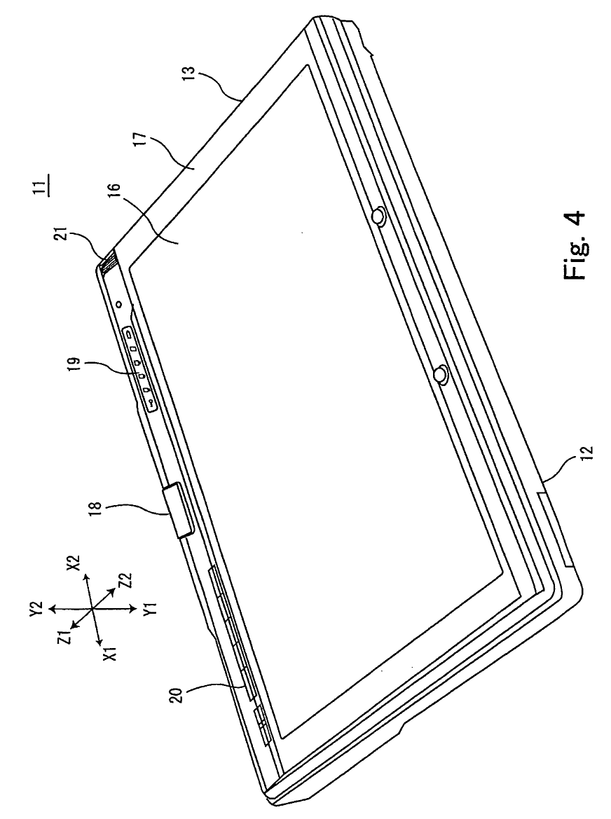

FIG. 3 shows an exterior appearance of the notebook computer 11 of the present invention in a state in which the display housing 13 is rotated from the state shown in FIG. 2, clockwise about the first rotation axis, and FIG. 4 shows an exterior appearance of the notebook computer 11 of the present invention in a state in which the display housing 13 is further rotated from the state shown in FIG. 3, clockwise about the first rotation axis, as well as being rotated about a horizontal axis, and the display housing 13 is closed over the main body housing 12.

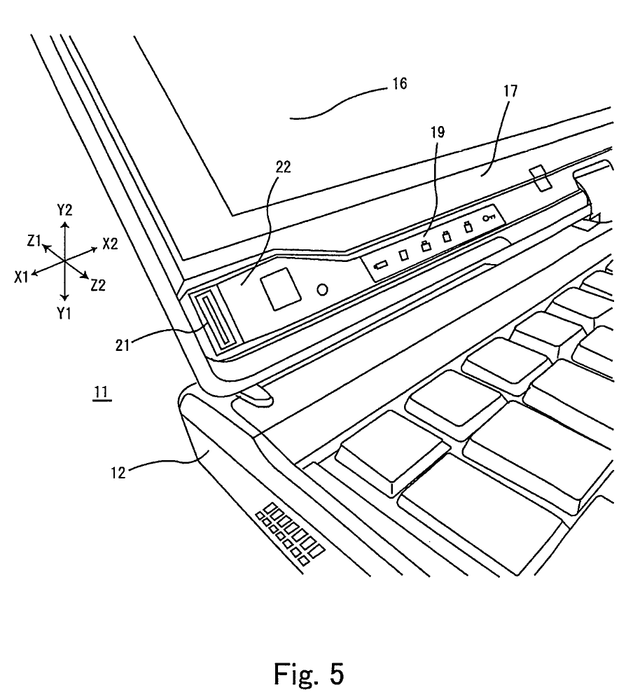

FIG. 5 shows a magnified view around the fingerprint reading sensor 21 of the notebook computer 11 in the state shown in FIG. 2.

The fingerprint reading sensor 21 is mounted at a deeper location than the reference surface of the display housing 13. The frame body 17 has a predetermined-length slant face section 22 slanting from the position adjacent to the end of the fingerprint reading sensor 21, along the first edge of the display housing 13, to the reference surface of the display housing 13. The slant face section 22 guides the operation by the finger allowing for successful fingerprint reading by the fingerprint reading sensor 21. That is to say, when the user moves his/her finger from the slant face section 22 toward the fingerprint reading sensor 21, the fingerprint reading sensor 21 scans the fingerprint. As a result of the operation by the finger by the user along the slant face section 22, fingerprint data scanned and obtained by the fingerprint reading sensor 21 is temporarily stored in a memory, for example. The fingerprint reading sensor 21 is used at login authentication to an operating system (OS) or to a network, or at startup of a software program. The user registers the fingerprint data of his/her left or right finger with the notebook computer 11 in advance. For example, based on a software program for fingerprint authentication stored in the HDD, the CPU checks the obtained fingerprint data against the fingerprint data previously stored in the HDD to authenticate the fingerprint.

In this manner, since the fingerprint reading sensor 21 is provided at a position along the first edge of the display housing 13, and the distance from the vertical axis of the rotation mechanism 18 is shorter compared to when the sensor is disposed on the lateral portion of the screen of the display housing 13, the rotation of the display housing 13 about the vertical axis, which is caused by a force applied by the operation by the finger for fingerprint reading, is prevented. Further, since the fingerprint reading sensor 21 is mounted on the display housing 13 by using a space required for mounting the rotation mechanism 18 on the first edge of the display housing 13, the fingerprint reading sensor 21 is mounted on the electronic apparatus without expanding the contour size of the notebook computer 11. Furthermore, when the resistance film type touch panel is mounted on the display screen of the LCD panel 16, the touch panel on the display screen is no longer accidentally operated due to the operation by the finger for fingerprint reading, allowing erroneous operations on the electronic apparatus to be prevented.

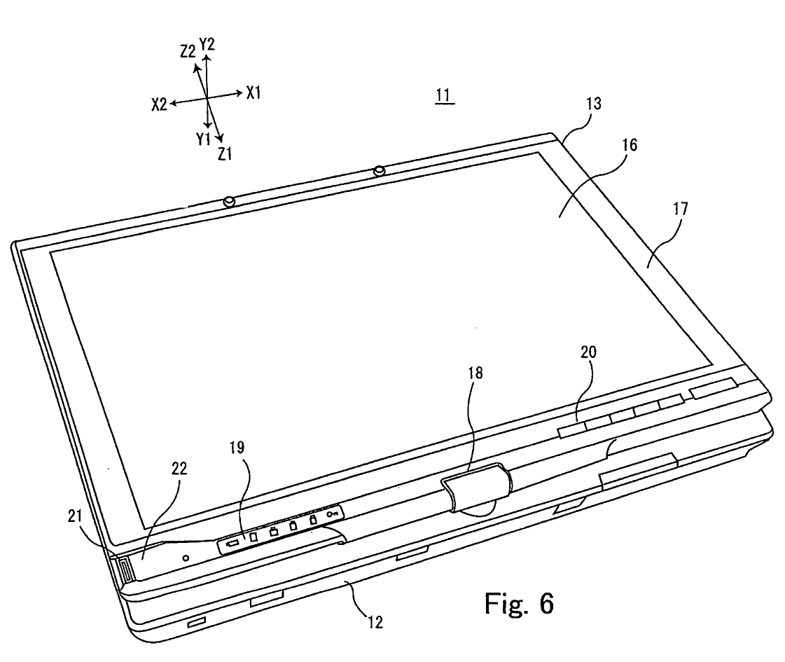

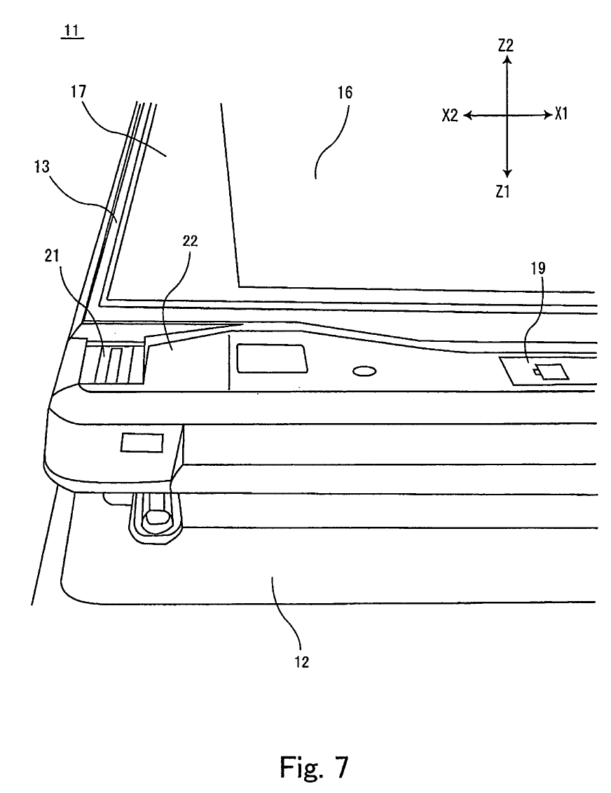

FIG. 6 shows an exterior appearance of the notebook computer 11 in the state shown in FIG. 4 viewed from a z1 direction to a z2 direction, and FIG. 7 shows a magnified view around the fingerprint reading sensor 21 of the notebook computer 11 in the state shown in FIG. 6.

Note that, in order to mount the LCD panel 16 on the display housing 13, a fixing mechanism for the LCD panel 16 has to be provided between the lateral portion of the LCD panel 16 under the frame body 17 and the side wall of the display housing 13 (frame body 17). Electronic components can be mounted in the free space within the space provided for the fixing mechanism. Mounting an antenna for receiving TV airwaves as the electronic component, for example, allows remarkably excellent airwave to be received.

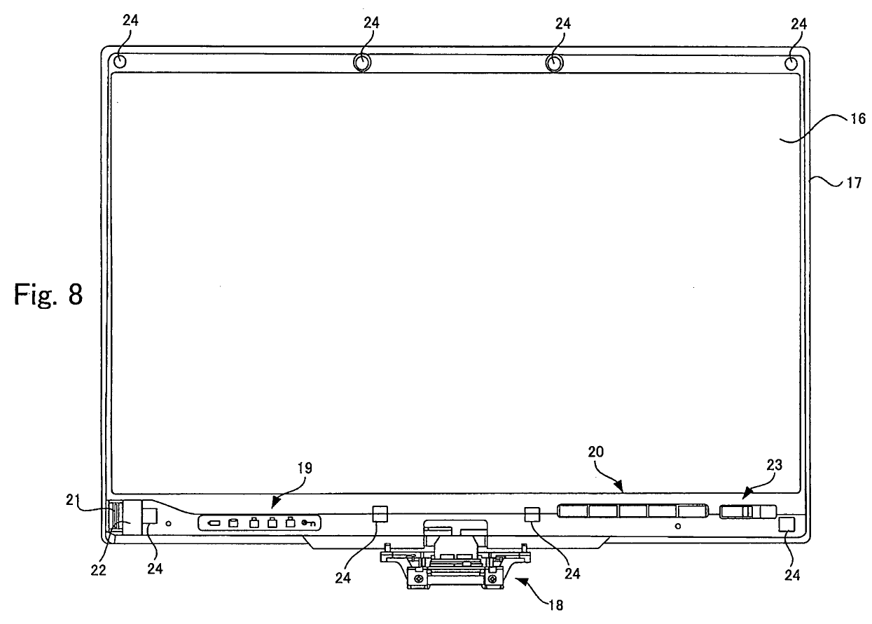

FIG. 8 is a front view that shows only the display housing of the notebook computer of the present embodiment.

As described above, the LCD panel 16 is provided in the center of the display housing, and the frame body 17 is spread around the LCD panel 16. The fingerprint reading sensor 21 is provided on the first edge, that is, on the left end of the lower edge having the rotation mechanism 18, and the slant face section 22 is formed next to the fingerprint reading sensor 21.

Further, display windows for the incorporated LED group 19 are provided on the lower edge thereof, and an illustration depicting each status is placed above each display window. Furthermore, a button group for pushing down the built-in operating switch group 20 is disposed on the right side thereof, and further on the right thereof, an operator for operating a built-in power switch 23 for powering-on is disposed.

In addition, FIG. 8 shows screw concealers 24 that cover screws for assembly at four locations on the upper edge and at four locations on the lower edge.

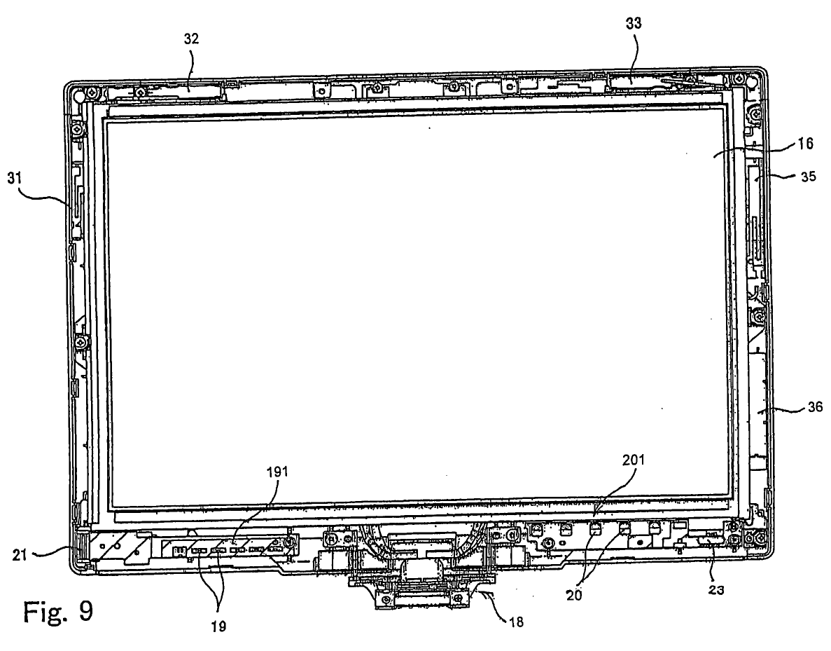

FIG. 9 is a front view of the display housing shown in FIG. 8 with the frame body around the LCD panel removed.

In FIG. 9, an indicator substrate 191 on which the LCD group 19 is mounted, and an operation substrate 201 on which the operating switch group 20 is mounted, are disposed on the lower edge, and the power switch 23 is disposed on the right thereof.

Further, an antenna 31 is disposed between the LCD panel 16 and the periphery on the second edge according to the present invention, that is, on the left edge of the LCD panel 16. The antenna 31 is an antenna for wireless LAN (IEEE 802.11n).

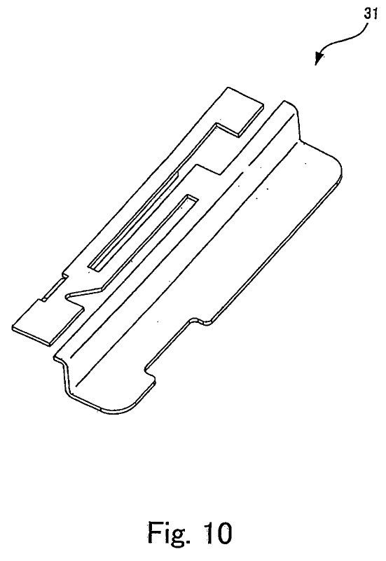

FIG. 10 shows a perspective view of the antenna for wireless LAN (IEEE 802.11n).

The antenna 31 is made of a metal sheet.

Furthermore, on the upper edge in FIG. 9, a total of two antennas 32 and 33 are disposed on left and right thereof, respectively. The two antennas 32, 33 are both antennas for wireless LAN (IEEE 802.11b/g), and have the same shape.

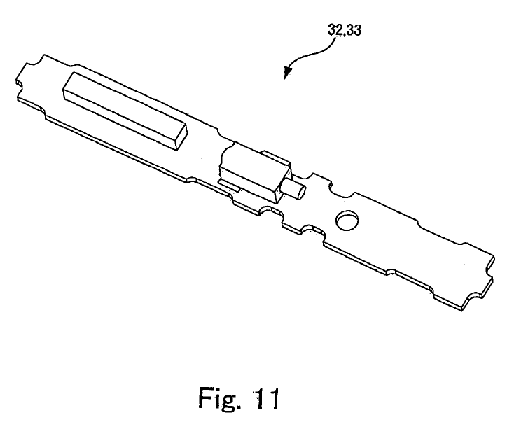

FIG. 11 shows a perspective view of the antenna for wireless LAN (IEEE 802.11b/g).

This antenna is mounted on the substrate, allowing for fine adjustment of a characteristic.

Note that FIG. 9 shows the back face of the antennas 32 and 33 shown in FIG. 11.

Further, two antennas 35 and 36 are disposed on the right side of FIG. 9 as well.

The two antennas 35 and 36 are both antennas for Universal Mobile Telecommunications System (UMTS) for communicating data using telephone lines; one among them, the antenna 35, is made of a metal sheet, and the other, the antenna 36, is mounted on the substrate, the two being in charge of diversity communication method, to achieve a high performance in transmission/reception.

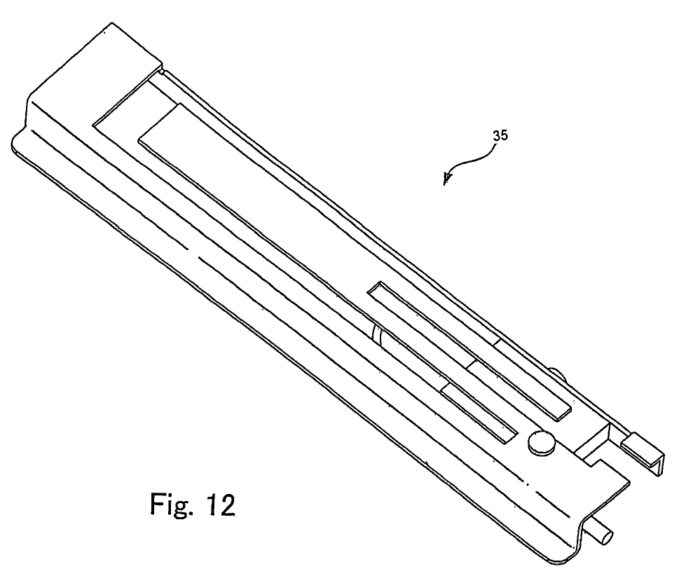

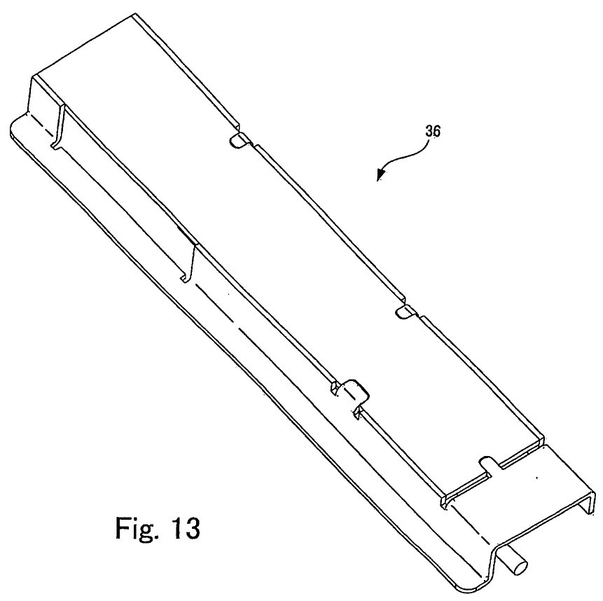

FIG. 12 shows a perspective view of the antenna 35 for UMTS, which is made of a metal sheet, and FIG. 13 shows a perspective view of the antenna 36 for UMTS, which is mounted on the substrate.

Note that the electronic apparatus of the present invention may include other electronic apparatuses such as mobile phone units and personal digital assistants (PDA), in addition to the notebook computer 11 described above.

What is claimed is:

1. An electronic apparatus, comprising:
a first housing;
a second housing that has a periphery having a first edge, and a second edge intersecting the first edge;
a coupling unit that has a first rotation axis in a direction intersecting with a surface of the first housing, and couples the first housing and the first edge of the second housing so that the second housing is rotatable about the first rotation axis with respect to the first housing; and
a fingerprint reading sensor provided on the first edge of the second housing.

2. The electronic apparatus according to claim 1, wherein the fingerprint reading sensor reads the fingerprint of a finger of an operation along the first edge.

3. The electronic apparatus according to claim 1, wherein the fingerprint reading sensor is provided at a position on the first edge of the second housing where the first edge and the second edge intersect with each other.

4. The electronic apparatus according to claim 1, wherein the second housing has a slant face section oriented from a portion adjacent to an end of the fingerprint reading sensor, which is provided on a deeper location of the second housing than the front face of the second housing, to the front face of the second housing.

5. The electronic apparatus according to claim 1, wherein the second housing has an electronic component in the second housing on the second edge.

6. The electronic apparatus according to claim 5, wherein the electronic component on the second edge is an antenna.

7. The electronic apparatus according to claim 5, wherein the second housing has a frame body that constitutes the periphery and houses the electronic component in the second housing on the second edge.

8. The electronic apparatus according to claim 1, wherein the second housing has an electronic component on the first edge.

9. The electronic apparatus according to claim 8, wherein the electronic component on the first edge is an operating switch.

10. The electronic apparatus according to claim 8, wherein the electronic component on the first edge is an indicator that indicates a predetermined operating state of the electronic apparatus.

11. The electronic apparatus according to claim 8, wherein the second housing has a frame body that constitutes the periphery and has the electronic component on the first edge.

12. The electronic apparatus according to claim 1, wherein the coupling unit has a second rotation axis that allows the second housing to be opened/closed with respect to the first housing, and has a second rotation axis positioned on the side of the second housing, and parallel to the surface of the first housing.

13. The electronic apparatus according to claim 1, wherein the first housing is an apparatus main section, and the second housing is a display section having a screen.

14. The electronic apparatus according to claim 13, wherein the second housing has an input device that allows a coordinate specification to be entered at a position of the screen.

15. The electronic apparatus according to claim 13, wherein the first housing has a keyboard on the surface.

16. An electronic apparatus, comprising:
a first housing;
a second housing that has a periphery having a first edge, and a second edge intersecting the first edge;
a coupling unit that has a first rotation axis in a direction intersecting with a surface of the first housing, and couples the first housing and the first edge of the second housing so that the second housing is rotatable about the first rotation axis with respect to the first housing;
a fingerprint reading sensor provided on the first edge of the second housing; and
an antenna that is incorporated into the second edge of the second housing.

17. The electronic apparatus according to claim 16, wherein the second housing has a frame body that constitutes the periphery and houses the antenna in the second housing on the second edge.

18. The electronic apparatus according to claim 17, wherein the frame body holds a display unit, which has a display screen where information is displayed, at a position inside from the periphery with the display screen exposed, and the antenna is positioned at a more peripheral position than the display unit, along the second edge.

19. The electronic apparatus according to claim 18, wherein another antenna is incorporated at a position between the periphery of the frame body and the display unit.
